(19) United States
(12) Patent Application Publication
(10) Pub. No.: US 2004/0031588 A1
(43) Pub. Date: Feb. 19, 2004

(54) Heat sink and method of removing heat from power electronics components

(75) Inventor: John Makaran, London (CA)

Correspondence Address: Siemens Corporation, Intellectual Property Deparment, 170 Wood Avenue South, Iselin, NJ, 08830, US

(73) Assignee: Siemens VDO Automotive Inc.

(21) Appl. No.: 10/456,921

(22) Filed: Jun. 6, 2003

Related U.S. Application Data
(62) Division of application No. 10/117,547, filed on Apr. 2, 2002, now abandoned.

(51) Int. Cl. F28F 7/00; F25B 29/00; B23P 15/26; B21K 21/00; B21D 53/06

(52) U.S. Cl. 165/80.3; 165/76; 165/185; 165/905; 29/890.035

(57) ABSTRACT

A heat sink 28 is provided for removing heat from a component 30 on a circuit board 22. The heat sink 28 includes a base 12 having a top 14, a bottom 16, and opposing sides 18 and 20. The top is generally planar for being adhered to a circuit board. Each of the opposing sides has a cutout defining a stepped shoulder 26. The heat sink also includes a plurality of fins 24 extending from the bottom of the base. Locating structure 50 is provided on the top of the heat sink for locating the heat sink with respect to the circuit board 22. Since the heat sink can be glued to the circuit board, a common heat sink can be used for any power electronics component.

### FIELD OF THE INVENTION

The invention relates to heat removal from electronic components of a circuit board and, more particularly, to a heat sink for removing heat from a power electronics component.

### BACKGROUND OF THE INVENTION

Typically, heat sinks for removing heat from power electronics components of a circuit board are designed for the specific component to be cooled. Development time is significant since a thermal model and thermal stack-up need to be determined for each heat sink. In making heat sinks, costly tooling is required, especially if the heat sink is of the finned type. Furthermore, rapid reconfiguration of a printed circuit board layout is difficult and expensive since there is retooling associated with the conventional heat sinks. This often results in solutions that are unique to the particular packaging embodiment.

Accordingly, there is a need to provide a heat sink to be used for all power electronic devices.

### SUMMARY OF THE INVENTION

An object of the invention is to fulfill the need referred to above. In accordance with the principles of the present invention, this objective is achieved by providing a heat sink for removing heat from a component on a substrate. The heat sink includes a base having a top, a bottom and opposing sides. The top is generally planar for being adhered to the substrate. Locating structure is provided on the top of the heat sink for locating the heat sink with respect to the substrate. Each of the opposing sides has a cutout defining a stepped shoulder. The heat sink also includes a plurality of fins extending from the bottom of the base. The heat sink is made preferably by an extrusion process. Since the heat sink can be glued to the circuit board, a common heat sink can be used for any power electronics component.

In accordance with another aspect of the invention, a method is provided for removing heat from a component mounted on a substrate. The method provides a heat-generating component on a top side of the substrate. A heat sink is provided and has a base including a top, a bottom and opposing sides. The top is generally planar for mounting to the substrate. The heat sink also includes a plurality of fins extending from the bottom of the base. Thermal adhesive is applied to the bottom of the substrate or to at least a portion of the top of the heat sink and the top of the heat sink is secured to the bottom side of the substrate to remove heat from the component.

In accordance with yet another aspect of the invention, a method of making a heat sink includes extruding material to form a heat sink extrusion of a certain length. The heat sink extrusion has a base including a top, a bottom and opposing sides. The top is generally planar for mounting to a circuit board. The heat sink extrusion also includes a plurality of fins extending from the bottom of the base. A cutout is machined at each of the opposing sides to define stepped shoulders. The extrusion is cut across the length at various locations to provide a plurality of heat sinks from the extrusion.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a perspective view of a heat sink extrusion provided in accordance with principles of the present invention.

FIG. 2 is a perspective view of a heat sink cut from the extrusion of FIG. 1, shown after creating shoulders in opposing sides thereof.

FIG. 3 is a cross-sectional view of the heat sink of FIG. 2 shown mounted between a circuit board and a cover member in accordance with the present invention.

FIG. 4 is a perspective view of a second embodiment of a heat sink of the invention shown having locating structure on a top thereof.

FIG. 5 is a plan view of one of the location structures of the heat sink of FIG. 4 shown received in a through hole in a circuit board.

### DETAILED DESCRIPTION OF THE EXEMPLARY EMBODIMENT

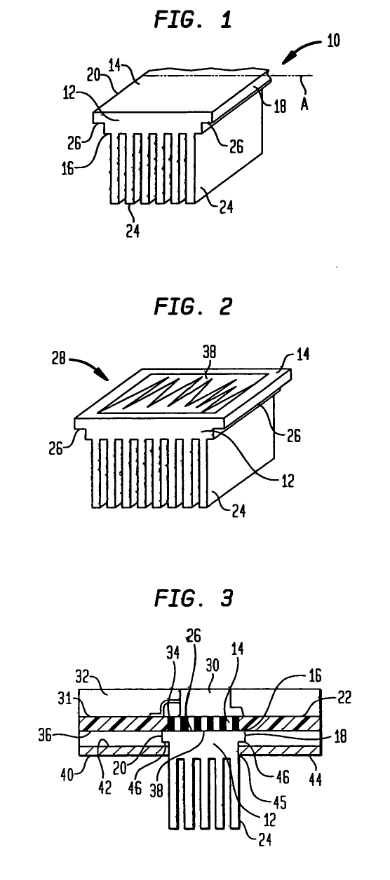

With reference to FIG. 1, a heat sink extrusion, provided in accordance with the invention, is shown generally indicated at 10. Material, such as aluminum or magnesium, is extruded to form the heat sink extrusion 10 having a certain length. The heat sink extrusion 10 has a base 12 including a top 14, a bottom 16 and opposing sides 18 and 20. The top 14 is generally planar for mounting to substrate such as a printed circuit board 22 (FIG. 3). The heat sink extrusion 10 also including a plurality of fins 24 extending from the bottom 16 of the base 12. As used herein the term “fins” means any structure to cause heat transfer from the base 12 to surrounding air. A cut-out is machined in each of the sides 18 and 20 defining stepped shoulders 26 in the base 12, the function of which will be explained below. Hence, by extrusion, the base 12 and the fins 24 are formed integrally.

In order to provide a plurality of heat sinks 28, generally indicated at 28 in FIG. 2, from the extrusion 10, the extrusion 10 is cut across the length at various locations (e.g., line A of FIG. 1). Thus, many heat sinks 28 can be made from a single extrusion 10. It can be appreciated that the heat sink can be made by methods other than extrusion, such as machining or casting.

With reference to FIG. 3, a method of removing heat from a component mounted on a substrate such as a circuit board provides a heat-generating component 30 mounted on a top side 31 of a circuit board 22. The substrate is preferably of ceramic or insulated metal material. In the illustrated embodiment, the heat-generating component 30 is a power electronics component such as a MOSFET. The component 30 is preferably covered with potting or conformal coating 32. Thermal vias 34 are provided through the circuit board 22 adjacent to the component 30 and extend from the top side 31 to a bottom side 36 of the circuit board 22. In the illustrated embodiment, the vias 34 are bores through the circuit board that are filled with thermally conductive material. Thus, the vias 34 provide paths for heat to be transferred from the component 30 to the bottom side 36 of the circuit board 22. Thermal adhesive 38 is applied to at least a portion of the top of heat sink 28 and the top 14 of the heat sink is secured to the bottom side 36 of the circuit board 22 adjacent to the vias 34. Of course, the adhesive can be applied to the bottom of the circuit board instead of applying adhesive on the heat sink. It can be appreciated that the thermal vias are not required, but are preferred since they aid in heat transfer.

In the illustrated embodiment, a cover member 40, preferably of plastic or aluminum, is provided and has a top surface 42, a bottom surface 44, and a bore 45 there-through. At least the top surface 42 is generally planar. The cover member 40 is configured to cover and protect the bottom side 36 of the circuit board 22 without contacting any portions of electrical components on the bottom side 36 of the circuit board 22. In the broadest aspect of the invention, the cover member need not be provided.

A sealant 46, such as silicone or RTV, is placed under each shoulder 26 of the base 12 of the heat sink 28, or around the bore 45 in the cover member 40. Thereafter, the fins 24 of the heat sink 28 are inserted through the bore 45 so that the sealant 46 is between the top surface 42 of the cover member 40 and the shoulders 26, sealing the bore 45.

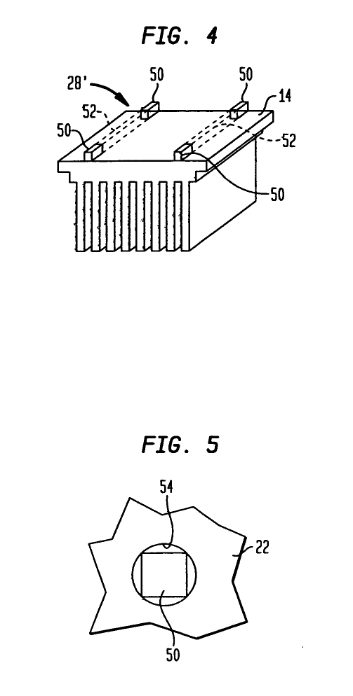

With reference to FIG. 4, to aid in locating the heat sink 28′ with respect to the circuit board 22, locating structure is provided on the top 14 of the base 12. The locating structure includes at least one pair of locators 50, of generally rectangular cross-section, extending from the top 14 of the base. Preferably, during extrusion of the heat sink, ribs 52 can be provided on the top 14 of the base 12. Then, as shown in FIG. 4, the central portions of the ribs can be removed by machining to define the locators 50. The locators 50 can be of any cross-sectional shape.

As shown in FIG. 5, the circuit board 22 can have plated locating holes 54 there-through, each of which is sized to receive an associated locator 50 of the heat sink 28 to control the X-Y location of the heat sink 28 with respect to the circuit board 22.

Thus, in accordance with the invention, a common heat sink can be used for all power electronic devices by simply gluing the heat sink to the circuit board relative to the power electronics device. Since the heat sink is a common design, rapid reconfiguration of printed circuit board layout can be achieved. There are no retooling costs associated with the heat sink 28. Only the location of the bore 45 in the cover member 40 needs to be moved during reconfiguration.

The advantages of the invention include: 1) shorter electronics package, 2) easier to re-layout a printed circuit board in an existing application or use in a new application because the heat sink dimensions are common to all designs, 3) no heat sink retooling costs, 4) ability to use finned heat sinks without the need for expensive tooled heat sinks, 5) heat sinks are extruded and therefore are of low cost, 6) minimize development time since heat sink thermal model and thermal stack-up is common to all designs, and 7) if more surface area is needed, a different extrusion with more or longer fins can be used.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A heat sink for removing heat from a component on a substrate, the heat sink comprising:
a base having a top, a bottom and opposing sides, the top being generally planar for being adhered to a substrate, each of the opposing sides having a cutout defining a stepped shoulder, and
a plurality of fins extending from the bottom of the base.

2. The heat sink of claim 1, wherein the base and fins are formed integrally.

3. The heat sink of claim 2, wherein the base and fins are an extrusion.

4. The heat sink of claim 2, wherein the base and fins are composed of one of aluminum and magnesium.

5. The heat sink of claim 1, further comprising locating structure on the top of the base for locating the heat sink with respect to a substrate.

6. The heat sink of claim 5, wherein the locating structure includes a plurality of members of generally rectangular cross-section extending from the top of the base.

7. A heat sink for removing heat from a component on a substrate, the heat sink comprising:
a base having a top, a bottom and opposing sides, the top being generally planar for being adhered to a substrate, the base including locating structure on the top thereof for locating the heat sink with respect to a substrate, and
a plurality of fins extending from the bottom of the base.

8. The heat sink of claim 7, wherein the locating structure includes a plurality of members of generally rectangular cross-section extending from the top of the base.

9. A method of removing heat from a component mounted on a substrate, the method including:
providing a heat-generating component on a top side of a substrate,
providing a heat sink having a base including a top, a bottom and opposing sides, the top being generally planar for mounting to a circuit board, the heat sink also including a plurality of fins extending from the bottom of the base, and
applying thermal adhesive to the bottom of the substrate or at least a portion of the top of the heat sink and securing the top of the heat sink to the bottom side of the substrate so as to remove heat from the component.

10. The method of claim 9, wherein each of the opposing sides of the heat sink has a cutout defining a stepped shoulder, the method further comprising:
providing a cover member having a top surface and a bottom surface, and a bore there-through, at least the top surface being generally planar,
inserting the fins through the bore with sealant, provided between the top surface of the cover member and the shoulders, sealing the bore.

11. The method of claim 9, wherein the component provided is a power electronics component.

12. The method of claim 11, wherein the power electronics component is a MOSFET.

13. The method of claim 10, wherein the cover member is composed of one of plastic and aluminum and is configured to protect the bottom side of the substrate without contacting any portions of electrical components on the bottom side of the substrate.

14. The method of claim 9, wherein the sealant is silicone.

15. The method of claim 9, wherein the heat sink is composed of one of aluminum and magnesium.

16. The method of claim 9, wherein the top of the base includes locating structure and the substrate includes locating holes therein, the securing step including placing the locating structure in the locating holes.

17. The method of claim 9, wherein the adhesive applied to the portion of the top of the base.

18. A method of making a heat sink comprising:
extruding material to form a heat sink extrusion of a certain length, the heat sink extrusion having a base including a top, a bottom and opposing sides, the top being generally planar for mounting to a circuit board, the heat sink extrusion also including a plurality of fins extending from the bottom of the base,
machining, at each of the opposing sides, a cutout defining a stepped shoulder, and
cutting the extrusion across the certain length at various locations to provide a plurality of heat sinks from the extrusion.

19. The method of claim 18, wherein the extrusion further includes at least one rib on the top of the base extending the certain length, after the cutting step, the method including removing a central portion of the rib to define locating structure.

20. The method of claim 19, wherein the locating structure comprises at least one pair of locators, each locator having a generally rectangular cross-section.
